(19) United States
(12) Patent Application Publication
(10) Pub. No.: US 2014/0250105 A1
(43) Pub. Date: Sep. 4, 2014

(54) RELIABLE CONTENT RECOMMENDATIONS

(71) Applicant: Google Inc., (US)

(72) Inventor: Umesh Shankar, New York, NY (US)

(21) Appl. No.: 13/784,543

(22) Filed: Mar. 4, 2013

(51) Int. Cl. G06F 17/30

(52) U.S. Cl. CPC G06F 17/30424
USPC 707/722

(57) ABSTRACT

A method and/or system for reliable content recommendations may include receiving, from an electronic device, a request for one or more content recommendations. An indicator associated with the electronic device may be determined. A history of interactions, wherein the interactions may be associated with the indicator, may also be determined. One or more entity root certificates may be determined based on the history of interactions. Based on the one or more entity root certificates, one or more entities may be determined. One or more recommended content items may be determined, where the one or more recommended content items may be associated with the one or more entities. Content recommendation data may be communicated, to the electronic device, where the content recommendation data may comprises data related to the one or more recommended content items.

### TECHNICAL FIELD

Aspects of the present application relate to electronic devices. More specifically, certain implementations of the present disclosure relate to a method and/or system for reliable content recommendations.

### BACKGROUND

Various types of electronic devices are now commonly utilized. In this regard, electronic devices may include, for example, personal and non-personal devices, mobile and non-mobile devices, communication (wired and/or wireless) devices, general and special purpose devices. Examples of electronic devices may comprise cellular phones, smartphones, tablets, personal computers, laptops and the like. In some instances, various applications may run on the electronic devices. The applications may be directed to game application, personal applications and/or business applications.

Further limitations and disadvantages of conventional and traditional approaches will become apparent to one of skill in the art, through comparison of such approaches with some aspects of the present method and/or system set forth in the remainder of this disclosure with reference to the drawings.

### BRIEF SUMMARY

Method and/or system for reliable content recommendations, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 is a block diagram of an example system for reliable content recommendations, in accordance with an example embodiment of the disclosure.

FIG. 2 is a block diagram of example electronic device that supports reliable content recommendations, in accordance with an example embodiment of the disclosure.

FIG. 3 is a block diagram of example recommendation server that supports reliable content recommendations, in accordance with an example embodiment of the disclosure.

FIG. 4 is a flow diagram of example steps of a method for reliable content recommendations, in accordance with an example embodiment of the disclosure.

FIG. 5 is a flow diagram of example steps of another method for reliable content recommendations, in accordance with an example embodiment of the disclosure.

### DETAILED DESCRIPTION

Certain embodiments of the disclosure may be found in a method and/or system for reliable content recommendations. In various embodiments of the disclosure, a method and/or system for reliable content recommendations may include receiving, from an electronic device, a request for one or more content recommendations (e.g., application recommendations). An identifier associated with the electronic device may be determined. The identifier may correspond to a particular user that may be associated with the electronic device. A history of interactions, where the interactions may be associated with the identifier (e.g., user interactions associated with the particular user), may also be determined. The history of interactions may comprise interactions with web, e-mail or applications. One or more entity root certificates may be determined based on the history of interactions. The one or more entity root certificates may comprise security data. The security data may indicate that the one or more entities are related to the history of interactions. Based on the one or more entity root certificates, one or more entities may be determined. The one or more entities may be related to the history of interactions. One or more recommended content items (e.g., applications, media items, etc.) may be determined, where the one or more recommended content items are associated with the one or more entities. Content recommendation data may be communicated to the electronic device. The content recommendation data may comprise data related to the one or more recommended content items, and/or one or more indicators, each associated with one of the one or more recommended content items, where the one or more indicators may be related to a reason for recommending the one or more recommended content items. One or more indicators may comprise data related to informing the particular user that the one or more recommended content items is reliable.

In an example embodiment of the disclosure, interaction data (e.g., user interaction data) may be collected. The interaction data may be analyzed for one or more root certificates. Relevant interaction data may be determined based on, for example, the analyzing. The relevant interaction data may be communicated to a server (e.g., a recommendation server). Content recommendation data may be received from the server. The content recommendation data may be based on the relevant interaction data. The content recommendation data may comprise one or more recommended content items (e.g., applications, media items, etc.) and/or one or more indicators, each associated with the one or more recommended content items.

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “block” refers to functions, processes, threads, etc. than can be performed by one or more circuits. As utilized herein, the term “e.g.,” introduces a list of one or more non-limiting examples, instances, or illustrations. As utilized herein, the term “server” may refer to a plurality of machines, at least some of which may be installed in different locations, and each of which may be utilized to implement distinct and/or redundant functions associated with operations attributed to and/or performed by the server.

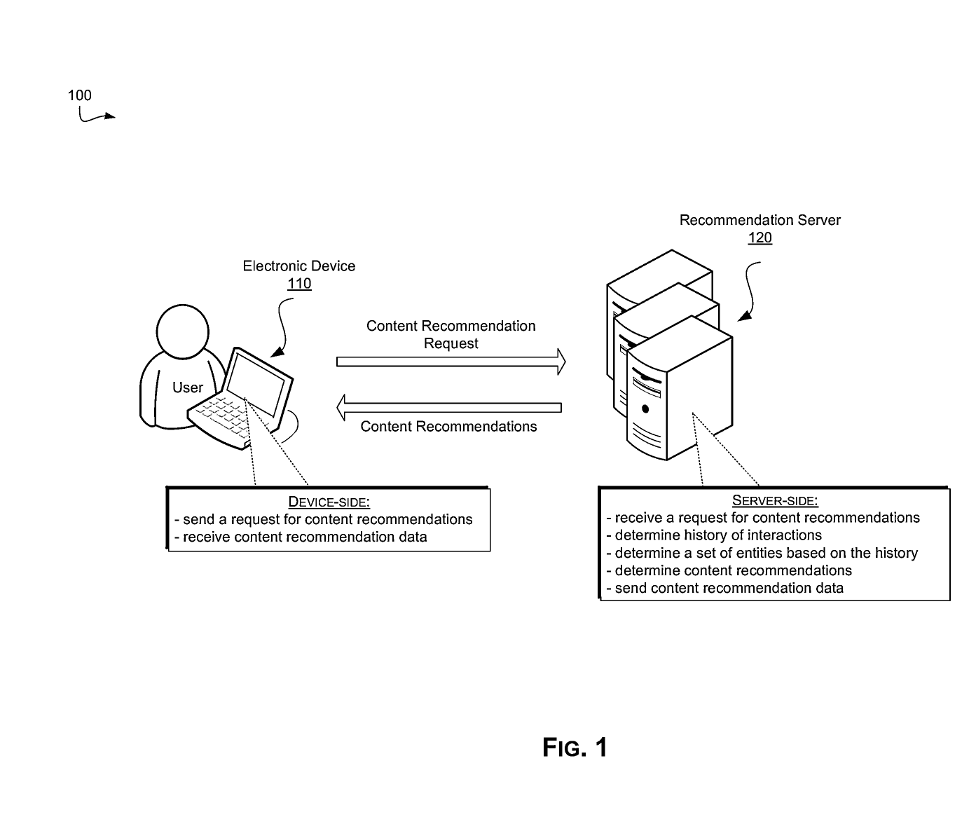

FIG. 1 is a block diagram of an example system for reliable content recommendations, in accordance with an example embodiment of the disclosure. Referring to FIG. 1, there is shown a system for reliable content recommendations 100. The system 100 may comprise an electronic device 110 and a recommendation server 120.

The electronic device 110 may comprise suitable logic, circuitry, interfaces, and/or code that may be operable to communicate data and/or messages via wired and/or wireless connections configured in accordance with one or more supported wireless and or wired protocols, standards and/or interfaces (e.g., Ethernet, Bluetooth, WiFi, cellular, WiMAX, WLAN, NFC, etc.). The electronic device 110 may be operable to process, generate, present and/or output data and/or messages. The electronic device 110 may be enabled to perform, run, and/or execute various functions, operations, applications and/or programs based on, for example, user instructions and/or interactions, and/or pre-configured instructions. In this regard, the electronic device 110 may be operable to communicate, for example, with the recommendation server 120.

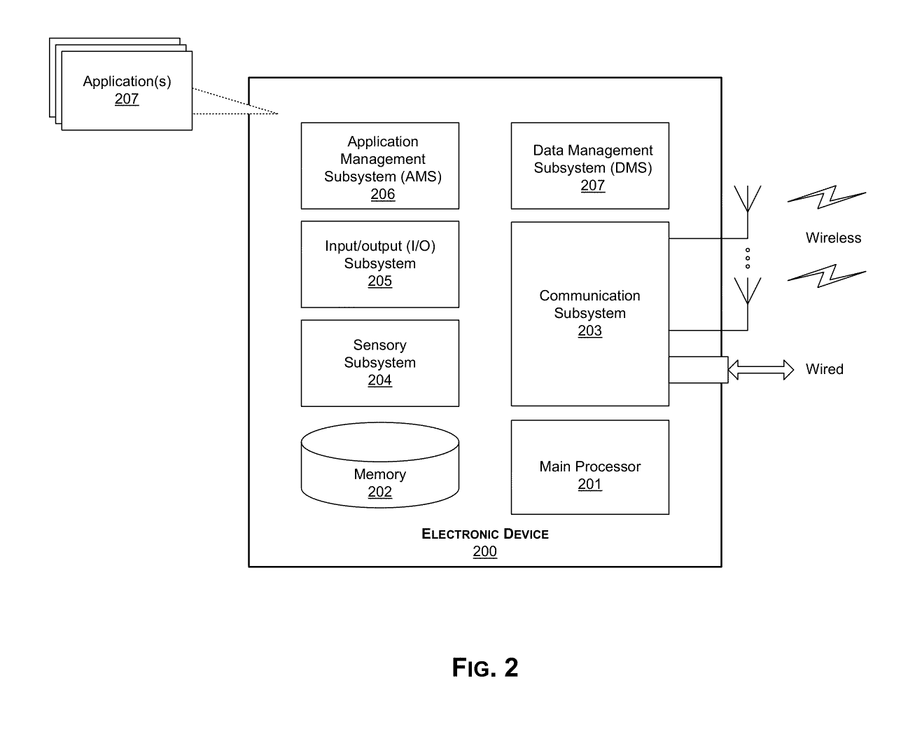

The electronic device 110 may comprise a cellular phone, smartphone, tablet, set-top box, television, laptop computer, desktop and/or personal computer, personal media player, other device which may communicate, process, generate, present and/or output data and/or other device that supports reliable content recommendations (e.g., reliable application recommendations). The disclosure, and/or any implementation(s) in accordance therewith, however, are not limited to any particular type of an electronic device. The electronic device 110 may, for example, comprise the electronic device 200 as depicted and/or described with respect to FIG. 2.

The recommendation server 120 may comprise suitable logic, circuitry, interfaces, and/or code that may be operable to provide reliable content recommendation services (e.g., application recommendation services) to electronic devices, such as for example, the electronic device 110. For example, the recommendation server 120 may be enabled to provide reliable content recommendation services (e.g., reliable application recommendation services).

The recommendation server 120 may be operable to communicate data and/or messages via wired and/or wireless connections configured in accordance with one or more supported wireless and or wired protocols, standards and/or interfaces (e.g. Ethernet, Bluetooth, WiFi, cellular, WiMAX, WLAN, NFC) with electronic devices, such as, for example, the electronic device 110. The recommendation server 120 may be enabled to process, store, manage and/or communicate data and/or messages relevant to providing reliable content recommendation services (e.g., reliable application recommendation services) to electronic devices, such as, for example, the electronic device 110. Furthermore, the recommendation server 120 may be operable to provide communication services to and from the electronic device 110. For example, the recommendation server 120 may include one or more transceivers for providing wired and/or wireless communication of data to and from the electronic device 110.

In an example embodiment of the disclosure, the recommendation server 120 may receive, store, manage and/or process information and/or data relating to user interactions (e.g., browsing, e-mail and other interactions history, etc.) and/or data and/or information otherwise relevant to the products and/or services provided by the recommendation server 120.

In an example embodiment of the disclosure, the recommendation server 120 may provide and/or manage user registration and/or authentication services. In this regard, a user of an electronic device, such as, for example, the electronic device 110, may register with the registration/authentication services provided by the recommendation server 120, by for example creating a user account. The user may register one or more electronic devices under the user account. The recommendation server 120 may provide user authentication services. For example, the recommendation server 120 may provide a prompt to the user to enter authentication information on the electronic device 110 through a graphical user interface (GUI). The electronic device 110 may send the authentication information to the recommendation server 120 for authenticating the user.

In an example embodiment of the disclosure, the recommendation server 120 may automatically authenticate the user or an electronic device associated with the user, such as, for example, the electronic device 110, when the electronic device 110 itself (e.g., without the user's intervention) or the user through the electronic device 110 sends a request, to an recommendation server, such as, for example, the recommendation server 120, for reliable content recommendations (e.g., reliable application recommendations). In this regard, when the recommendation server 120 receives the request, the recommendation server 120 may verify the identity of the electronic device 110. The recommendation server 120 may initiate and/or perform a search on a user registration database to determine whether the electronic device 110 corresponds to a particular user and authenticate the particular user based on the correspondence.

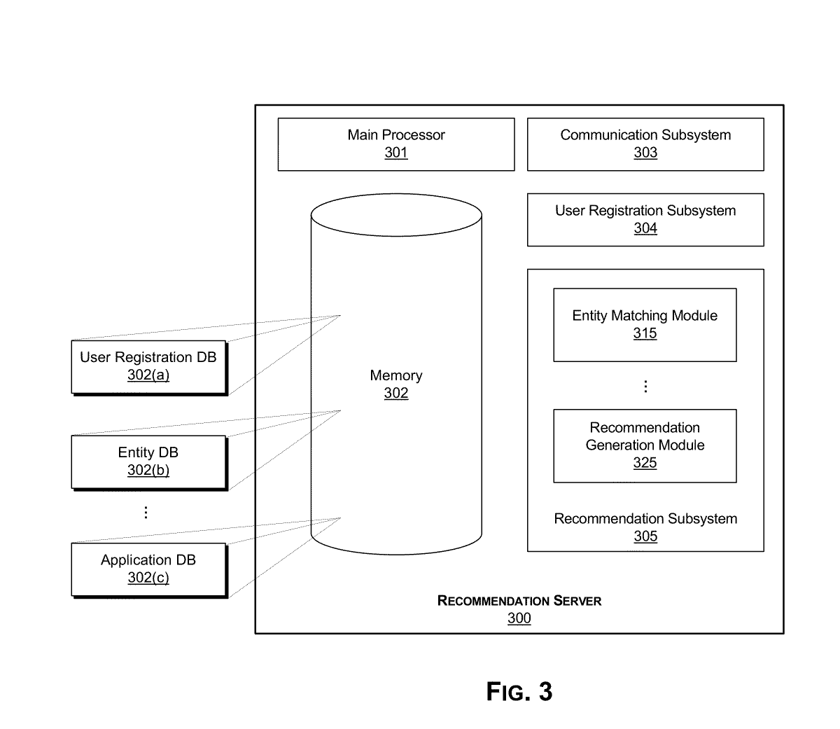

The recommendation server 120 may comprise a dedicated system and/or a general purpose system configured to provide reliable content recommendation services (e.g., reliable application recommendation services) to electronic devices, such as, for example, the electronic device 110. The disclosure, and/or any implementation(s) in accordance therewith, however, are not limited to any particular type of a recommendation server. The recommendation server 120 may, for example, comprise the recommendation server 300 as depicted and/or described with respect to FIG. 3.

In operation, an electronic device, such as, for example, the electronic device 110, may send a request, to a recommendation server, such as, for example, the recommendation server 120, for reliable content recommendations (e.g., reliable application recommendations). The request may be, for example, sent in response to user interactions with the electronic device 110 (e.g., accessing a particular application operable to send and/or initiate sending the request).

The recommendation server 120 may receive the request for reliable content recommendations (e.g., reliable application recommendations). In this regard, the recommendation server 120 may process the request and/or may determine reliable content recommendations (e.g., reliable application recommendations).

In an example embodiment of the disclosure a particular user associated with the electronic device 110 (and/or the request) may be determined. A history of user interactions (e.g., user interaction data) associated with the particular user may also be determined. The history of user interactions may be analyzed to determine one or more particular entities that may be uniquely identified based on, for example, an entity root certificate. In this regard, the recommendation server 120 may determine one or more entity root certificates that may be associated with the history of user interactions.

The recommendation server 120 may analyze the one or more entity root certificates for authenticity (e.g., whether the entity root certificates comprise security data that may guarantee that the user interactions are with the entity that is the subject of the entity root certificate).

In an example embodiment of the disclosure, the recommendation server 120 may compare the entity root certificates identified in the history of user interaction with a trusted collection of entity root certificates (e.g., collected in a database and/or otherwise authenticated list of entity root certificates) to uniquely identify a particular entity associated with a particular user interaction. In an example embodiment of the disclosure, the trusted collection of entity root certificates may be compiled by the recommendation server 120, may be, for example, published by particular entities and/or combined in a database hosted by a third-party and/or by the recommendation server 120 and/or may be based on a third-party certificate verification (e.g., signing) services.

In an example embodiment of the disclosure, a particular user interaction may be associated with a particular brand name that is in turn associated with a particular entity, where the particular entity may be associated with an entity root certificate. For example, the particular brand name may utilize an entity root certificate associated with the particular entity. The recommendation server 120 may be operable to determine that the particular brand name is associated with the particular entity based on the entity root certificate that may have been associated with the particular user interaction with the particular brand name.

In an example embodiment of the disclosure, the recommendation server 120 may utilize the entity identification (e.g., through entity root certificates) to provide reliable content recommendations (e.g., reliable application recommendations). For example, the reliable application recommendations are guaranteed to be associated with applications by first-parties. Specifically, a reliable recommended application may be guaranteed to be published (e.g., released to an application store, etc.) by the same entity that the user interacted with (e.g., based on the user interaction history, user interaction data, etc.). For example, a user may have interacted with Bank A. When the user browses for banking applications the user may discover, for example, two banking applications, Application A (published by Bank A, N.A.) and Application B (published by Bank A, Inc.). The user may be unable to distinguish which of the two applications is associated with Bank A that the user may have been interacting with. The recommendation server 120 may be operable to analyze the history of user interactions with, for example, Bank A and may be operable to, for example determine, that Application B (and not application A) is associated with Bank A, based on, for example, entity root certificates associated with the history of user interactions and/or the entity root certificates associated with Application A and/or Application B.

In an example embodiment of the disclosure, the electronic device 110 may receive, from a recommendation server 120, recommendation data. The electronic device 110 may determine whether the recommendation data may be presented to the user of the electronic device 110. The electronic device 110 may further determine a method of presenting and/or causing to be presented the recommendation data and/or may present and/or cause to be presented the recommendation data to the user of the electronic device 110. The recommendation data may comprise, for example, instructions for presenting one or more reliable recommended applications to the user of the electronic device and/or the one or more reliable recommended applications themselves. The recommendation data may comprise, for example, an indication of a reason for recommending a particular reliable recommended application to the user and/or an indication that a particular reliable recommended application is reliable (e.g., is guaranteed to be a first-party application, etc.).

In an example embodiment of the disclosure, applications that may be recommended by the recommendation server as reliable recommended applications may be associated with application-entity root certificates. The application-entity root certificates may be the same as the entity root certificates (and may be referred to interchangeably). The recommendation server 120 may determine that a particular application is reliable (e.g. may be recommends as a reliable recommended application) based on a comparison of an entity root certificate associated with a history of user interactions (e.g., and the entities determined from those interactions) and an entity root certificate associated with the particular application.

In an example embodiment of the disclosure, the electronic device 110 may analyze activity on the electronic device 110, such as, for example, analyze user initiated activity (e.g., application access, web-browsing, e-mail massage composition, etc.) and/or passive device activity (e.g., e-mail receipt, etc.). The electronic device 110 may collect data and/or information related to the user initiated and/or the passive device activity and may store, analyze, process and/or manage the data and/or information. The data and/or information may, for example, comprise e-mail, web-browsing, on-line shopping and/or other interactive and/or passive history associated with a user and/or the electronic device 110. The data and/or information may relate to particular entities (e.g., companies, brand names, etc.) that may be associated with entity root certificates. For example, an e-mail received on the electronic device 110 may comprise an entity root certificate related to an entity that may be related to the sender of the e-mail.

In another example, a particular web-site accessed by a user may comprise an entity root certificate that may be related to a publisher, owner and/or another entity providing products and/or services through the particular web-site. Furthermore, the data and/or information may comprise domain name, electronic signature, etc.

The electronic device 110 may send, to the recommendation server 120, user interaction data, such as, for example, browsing, e-mail and other interactions history, and/or data and/or information otherwise relevant to the products and/or services provided by the recommendation server 120.

In an example embodiment of the disclosure, the electronic device 110 may be associated with one or more users. For example, a user authentication may be based on user input to the electronic device 110 (e.g., providing login information). In this regard, a request for reliable content recommendations (e.g., reliable application recommendations) may comprise data and/or information that may be enabling to authenticate a particular user associated with the request (e.g., currently logged into the electronic device 110 and/or services provided by, for example, the recommendation server 120).

In another example embodiment of the disclosure, one or more electronic devices, such as, for example, the electronic device 110, may be associated with the same user. The user may be authenticated, for example, though a user account, under which the one or more electronic devices may be registered. In this regard, access to the user account may be enabled from the one or more electronic devices (e.g., the registered electronic devices) and/or any other electronic device that may enable the user to, for example, log into the user account.

In an example embodiment of the disclosure, the user interaction data may be analyzed with respect to an electronic device that the user interaction data may have been received from and/or with respect to a particular user account associated with the electronic device.

In situations in which an example embodiment of the disclosure may collect personal information about users (e.g., users of electronic devices), or may make use of personal information, the users may be provided with an opportunity to control whether programs, applications, functions and/or features collect user related information (e.g., information about a user's social network, social actions or activities, profession, a user's preferences, or a user's current location), and/or to control whether and/or how to receive reliable content recommendations (e.g., reliable application recommendations) from an recommendation server (e.g., recommendation server 120) that may be more relevant to the user.

In addition, certain data may be treated in one or more ways before it is stored and/or used, so that personally identifiable information is removed. For example, a user's identity may be treated so that no personally identifiable information can be determined for the user, or a user's geographic location may be generalized where location information is obtained (e.g., such as to a city, ZIP code, or state level), so that a particular location of a user cannot be determined. Thus, the user may have control over how information is collected about the user and used by, for example, a recommendation server (e.g., recommendation server 120).

It is to be understood that the present disclosure is not limited to a particular method of user and/or device authentication, user interaction data analysis and/or providing reliable content recommendations (e.g., reliable application recommendations). More specifically, the example embodiments of the disclosure were selected not to limit but to simplify the explanation of the present disclosure.

Even though the operation of the electronic device 110 and/or the recommendation server 120 may be at times illustrated with respect to recommending applications, the disclosure is not limited in this regard. More specifically, recommendations may relate to content other than applications, such as, for example, media content (e.g., streaming media, audio files, video files, books, magazines, articles, games, slide shows, camera captures, etc.), images, news articles, news, maps, etc. Also, the content and/or user interactions need not be received from an electronic device.

FIG. 2 is a block diagram of example electronic device that supports reliable content recommendations, in accordance with an example embodiment of the disclosure. Referring to FIG. 2, there is shown an electronic device 200.

The electronic device 200 may comprise suitable logic, circuitry, interfaces, and/or code that may be operable to implement various aspects of the disclosure. In this regard, the electronic device 200 may correspond to the electronic device 110, as depicted in and/or described with respect to FIG. 1. The electronic device 200 may comprise, for example, a main processor 201, a memory 202, a communication subsystem 203, a sensory subsystem 204, an input/output (I/O) subsystem 205, an application management subsystem (AMS) 206 and/or a data management subsystem (DMS) 207.

The main processor 201 may comprise suitable logic, circuitry, interfaces, and/or code that may be operable to process data, and/or control and/or manage operations of the electronic device 200, and/or tasks and/or applications performed therein. In this regard, the main processor 201 may be operable to configure, manage and/or control operations of various components and/or subsystems of the electronic device 200, such as, for example, the memory 202, the communication subsystem 203, the sensory subsystem 204, the I/O subsystem 205, the AMS 206 and/or the DMS 207, by utilizing, for example, one or more control signals. The main processor 201 may enable running and/or executing applications, programs and/or code, which may be stored, for example, in the memory 202. Alternatively, one or more dedicated application processors may be utilized for running and/or executing applications, programs and/or code in the electronic device 200. In some instances, the applications running and/or executing on the electronic device 200 may comprise a plurality of applications 207, which may support reliable content recommendations (e.g., reliable application recommendations).

The memory 202 may comprise suitable logic, circuitry, interfaces, and/or code that that may be operable to enable permanent and/or non-permanent storage, buffering, and/or fetching of data, code and/or other information, which may be used, consumed, and/or processed by the components of the electronic device 200. In this regard, the memory 202 may be enabled to store executable instructions to manage and/or configure, for example, the main processor 201, the communication subsystem 203, the sensory subsystem 204, the input/output (I/O) subsystem 205, the AMS 206 and/or the DMS 207. The memory 202 may store, for example, configuration data, which may comprise parameters and/or code, comprising software and/or firmware. The memory 202 may comprise different memory technologies, including, for example, read-only memory (ROM), random access memory (RAM), low latency nonvolatile memory, flash memory, solid-state drive (SSD), field-programmable gate array (FPGA), and/or other suitable electronic data storage capable of storing data, code and/or other information.

The communication subsystem 203 may comprise suitable logic, circuitry, interfaces, and/or code that may be operable to communicate data from and/or to the electronic device 200, such as via one or more wired and/or wireless connections. For example, the communication subsystem 203 may comprise one or more transceivers for providing wired and/or wireless communication of data. The communication subsystem 203 may be configured to support one or more wired and/or wireless protocols, standards and/or interfaces (e.g., Ethernet, Bluetooth, WiFi, satellite and/or cellular network, WiMAX, WLAN, NFC) facilitating transmission and/or reception of signals to and/or from the electronic device 200, and/or processing of transmitted or received signals in accordance with applicable wired or wireless protocols. In this regard, signal-processing operations may comprise filtering, amplification, analog-to-digital conversion and/or digital-to-analog conversion, up-conversion/down-conversion of baseband signals, encoding/decoding, encryption/decryption, and/or modulation/demodulation.

The sensory subsystem 204 may comprise suitable logic, circuitry, interfaces, and/or code that may be operable to obtain and/or generate sensory information, which may relate to the electronic device 200, its user(s), and/or its environment. For example, the sensory subsystem 204 may comprise positional or locational sensors (e.g., GPS, GNSS, WiFi, BT, BTL, BTLE sensors, etc.), ambient condition sensors (e.g., temperature, humidity, or light), and/or motion related sensors (e.g., accelerometer, gyroscope, pedometers, and/or altimeters).

The I/O subsystem 205 may comprise suitable logic, circuitry, interfaces, and/or code that may be operable to enable user interactions with the electronic device 200, obtain input from user(s) of the electronic device 200 and/or provide output to the user(s). The I/O subsystem 205 may support various types of inputs and/or outputs, including, for example, video, audio, and/or textual. In this regard, dedicated I/O devices and/or components, external to or integrated within the electronic device 200, may be utilized for inputting and/or outputting data during operations of the I/O subsystem 205. Example (external or integrated) I/O devices may comprise displays, mice, keyboards, touchscreens, voice input interfaces, still image and/or video capturing devices and/or other input/output interfaces and/or devices.

The AMS 206 may comprise suitable logic, circuitry, interfaces, and/or code that may be operable to manage applications and/or data and/or information related to applications. The AMS 206 may be operable to initiate, receive, process and/or manage a request for reliable content recommendations (e.g., reliable application recommendations) and/or application recommendations (e.g., reliable application recommendations) received by the electronic device 200 in response to a request for such reliable content recommendations (e.g., reliable application recommendations). In this regard, the AMS 206 may be operable to analyze user interactions with the electronic device 200 to determine whether and/or when to initiate sending a request to a recommendation system (e.g., recommendation server 120) for application recommendations.

In an example embodiment of the disclosure, the AMS 206 may analyze various applications (e.g., Application(s) 207) and/or processes running on the electronic device 200 to determine whether, for example, the user of the electronic device 200 requested application recommendations. More specifically, the AMS 206 may determine that, for example, the user accessed a particular application that may be operable to support application recommendations (e.g., application store application, web-browser application, etc.). The AMS 206 may further analyze whether the user requested application recommendations and/or whether a recommendation triggering event has occurred. For example, the user, while browsing an application store (e.g., through an applications tore application or web-browser application, etc.), may, through a user interface, request application recommendations (e.g., the user may select an option “Recommend Reliable Application”).

The DMS 207 may comprise suitable logic, circuitry, interfaces, and/or code that may be operable to collecting, analyzing, processing and/or managing data and/or information related to user interactions with the electronic device 200. In this regard, the DMS 207 may collect, analyze, process and/or manage data related to, for example, user interactions with programs and/or applications running on the electronic device (e.g., e-mail, web-browser program and/or application, etc.) and/or user interactions with functions of the electronic device 200 (e.g., location services, camera interface, etc.).

In operation, the electronic device 200 may analyze activity on the electronic device 200. In this regard, the DMS 207 may, for example, analyze user initiated activity (e.g., application access, web-browsing, e-mail massage composition, etc.) and/or passive device activity (e.g., e-mail receipt, etc.). The DMS 207 may collect data and/or information related to the user initiated and/or the passive device activity and may store, analyze, process and/or manage the data and/or information. The data and/or information may, for example, comprise e-mail, web-browsing, on-line shopping and/or other interactive and/or passive history associated with a user and/or the electronic device 200. The data and/or information may relate to particular entities (e.g., companies, brand names, etc.) that may be associated with entity root certificates. For example, an e-mail received on the electronic device 200 may comprise an entity root certificate related to an entity that may be related to the sender of the e-mail. In another example, a particular web-site accessed by a user may comprise an entity root certificate that may be related to a publisher, owner and/or another entity providing products and/or services through the particular web-site. Furthermore, the data and/or information may comprise domain name, electronic signature, etc.

In an example embodiment of the disclosure, the data and/or information collected by the DMS 207 may be processed. For example, during the processing of the data and/or information, all personal and/or user identifying information may be removed and/or encrypted. In this regard, the DMS 207 may retain data and/or other information necessary for supporting reliable content recommendations for the user of the electronic device 200 and/or for the electronic device 200.

The DMS 207 may request, from the communication subsystem 203, for the communication subsystem 203 to send data and/or information collected and/or processed by the DMS 207 to a recommendation system (e.g., recommendation server 120).

The electronic device 200 may also send a request for reliable content recommendations (e.g., reliable application recommendations). In this regard, the AMS 206 may analyze the electronic device (and/or its components, applications, processes and/or functions, etc.) to determine whether an event triggering a request for reliable content recommendations (e.g., reliable application recommendations) has occurred.

The AMS 206 may prepare a request for reliable content recommendations (e.g., reliable application recommendations). The AMS 206 may request, from the communication subsystem 203, for the communication subsystem 203 to send the request to a recommendation system (e.g., recommendation server 120). The communication subsystem 203 may send the request to the recommendation system (e.g., recommendation server 120).

In an example embodiment of the disclosure, the electronic device 200 may receive, from a recommendation system (e.g., recommendation server 120), recommendation data. In this regard, the communication subsystem 203 may receive and/or process the recommendation data and may send the recommendation data (processed or unprocessed) to the AMS 206. The AMS 206 may determine whether the recommendation data may be presented to the user of the electronic device 200. The AMS 206 may further determine a method of presenting and/or causing to be presented the recommendation data (processed or unprocessed) and/or may present and/or cause to be presented the recommendation data to the user of the electronic device 200. The recommendation data may comprise, for example, instructions for presenting one or more reliable recommended applications to the user of the electronic device and/or the one or more reliable recommended applications themselves.

FIG. 3 is a block diagram of example recommendation server that supports reliable content recommendations, in accordance with an example embodiment of the disclosure. Referring to FIG. 3, there is shown a recommendation server 300.

The recommendation server 300 may comprise suitable logic, circuitry, code, and/or interfaces that may be operable to implement various aspects of the disclosure. In this regard, the recommendation server 300 may correspond to the recommendation server 120 of FIG. 1. The recommendation server 300 may, for example, comprise a main processor 301, a memory 302, a communication subsystem 303, a user registration subsystem 304, and/or a recommendation subsystem 305.

The main processor 301 may comprise suitable circuitry, interfaces, logic, and/or code that may be operable to process data, and/or control and/or manage components, operations and/or functions of the recommendation server 300, and/or tasks performed therein. In this regard, the main processor 301 may configure and/or control operations of various components and/or subsystems of the recommendation server 300, such as, for example, the memory 302, the communication subsystem 303, the user registration subsystem 304, and/or the recommendation subsystem 305, by utilizing, one or more control signals.

The memory 302 may be substantially similar to, for example, the memory 202 of FIG. 2. In this regard, the memory 302 may comprise suitable logic, circuitry, interfaces, and/or code that that may be operable to enable permanent and/or non-permanent storage, buffering, and/or fetching of data, code and/or other information, which may be used, consumed, and/or processed by the components of the recommendation server 300. In this regard, the memory 302 may be enabled to store executable instructions to manage and/or configure, for example, the main processor 301, the communication subsystem 303, the user registration subsystem 304, and/or the recommendation subsystem 305.

The memory 302 may comprise one or more databases such, as for example, a user registration database 302(a), an entity database 302(b) and/or an application database 302(c).

The user registration database 302(a) may comprise a plurality of database objects each corresponding to a particular user of reliable content recommendation services, such as, for example, the reliable content recommendation services (e.g., reliable application recommendation services) provided by the recommendation server 300. In this regard, each database object may comprise information and/or data, such as, for example, user name, account password, information and/or data about electronic devices associated with the user (e.g., type, brand, model, name, phone number, serial number) and/or information and/or data related to a history of user interactions.

In an example embodiment of the disclosure, the history of user interactions may comprise data and/or information that may be related to, for example, product(s) and/or service(s) provided by the recommendation server 300, such as, for example, a history of user responses to reliable content recommendations from the recommendation server 300 (e.g., whether the user purchased and/or interacted with the content of the reliable content recommendations, whether the user marked up or down a particular application recommended by the recommendation server 300 etc.) and/or other information voluntarily submitted by the user (e.g., age, gender, digital content preferences).

In another example embodiment of the disclosure, the history of user interactions may comprise data and/or information that may be related to, for example, data user interactions with and/or on an electronic device, such as, for example, user initiated activity (e.g., application access, web-browsing, e-mail massage composition, etc.) and/or passive device activity (e.g., e-mail receipt, etc.). The data and/or information may, for example, comprise e-mail, web-browsing, on-line shopping and/or other interactive and/or passive history associated with a user and/or an electronic device on which the interactions may occur.

The entity database 302(b) may comprise a plurality of database objects each corresponding to a particular entity that may be associated with, for example, an individual and/or a company that may offer products and/or services that a user of an electronic device (e.g., electronic device 110) may interact with (e.g., games, on-line shopping, banking, social networking, etc.). A particular entity may also publish (e.g., release to an application store, etc.) application(s) related to the products and/or services provided by the particular entity. The entity database 302(b) may store, process and/or manage data and/or information for each database object (e.g., entity), such as, for example, entity name(s), entity root certificate(s), brand name(s) associated with the entity, domain names associated with the entity, etc.

In an example embodiment of a disclosure, each entity may be unique and may be associated with a unique entity root certificate, such that, a particular entity may, for example, be uniquely identified based on the entity root certificate. The entity root certificate may be utilized as a signature for, for example, various domain names, brands, application associated with the entity. In another example embodiment of the disclosure, a particular entity may be unique but may be associated with one or more unique entity root certificates. In this regard, a particular entity may be associated with multiple (one or more) entity root certificates, but a particular entity root certificate may only be associated with one entity. It is to be understood that the present disclosure is not limited to a particular implementation of uniquely identifying an entity through, for example, an entity root certificate. Specifically, an entity may be uniquely identified through a method implementing entity root certificate identification and/or through a method not impending entity root certificate identification.

In an example embodiment of the disclosure, an entity may be associated with one or more brand names. For example, “Company A” corresponding to a particular unique entity associated with a unique entity root certificate may provide, for example, e-mail services under a brand name “Company A” and video streaming services under a brand name “Best Videos.” The e-mail services may be provided, for example, though a website with a domain name corresponding to the brand name “Company A” (e.g., “www.companya.com”) and the video services may be provided, for example, though a website with a domain name corresponding to the brand name “Best Videos” (e.g., www.bestvideos.com“). While the domain names and/or brand names for the two example services may not reveal to a user of those services a common entity association, the two services may be provided by the same entity.

The entity database 302(b) may store, process and/or mange data related to an entity that may be associated with one or more services and/or products that may not reveal to the user of those services and/or products that the services and/or products are provided by the same entity. The entity database 302(b) may identify the particular entity that may provide one or more products and or services under one or more different brand names through, for example, a use of an entity root certificate (e.g., a common entity root certificate, etc.).

For example, products and/or services provided under different brand names (e.g., “Company A,” “Best Videos”) may be signed and/or authenticated though an entity root certificate corresponding to the same entity (e.g., “Company A” entity).

The application database 302(c) may comprise a plurality of database objects each corresponding to a particular application, such as, for example, an application name, application type (e.g., game, business application, personal application, social networking application, etc.) and/or a publishing entity associated with the application.

In an example embodiment of the disclosure, an application from the application database 302(c) may be associated with one or more entities in the entity database 302(b). For example, “Company A,” that provides, for example, banking services as “Bank A, Inc.,” may have released a banking application to an application store (that may be supported by the recommendation server 300), where the banking application may be intended for use on an electronic device (e.g., electronic device 110).

In an example embodiment of the disclosure, an association of an application from the application database 302(c) with a particular entity may be based on an entity root certificate. In this regard, an application in the application database 302(c) may, in addition to a description of an entity with which the application is associated (e.g., a name of a company that published the application, etc.), comprise an application-entity root certificate. The application-entity root certificate of a particular application may be the same and/or may correspond to an entity root certificate of a particular entity with which the particular application is associated. For the purpose of simplifying the explanation of the present disclosure an application-entity root certificate and an entity root certificate may be referred to interchangeably throughout the present disclosure.

The communication subsystem 303 may be substantially similar to, for example, the communication subsystem 203 as depicted in and/or described with respect to FIG. 2. In this regard, the communication subsystem 303 may comprise suitable logic, circuitry, interfaces, and/or code that may be operable to communicate data from and/or to the recommendation server 300, such as via one or more wired and/or wireless connections.

The user registration subsystem 304 may comprise suitable logic, circuitry, interfaces, and/or code that may be operable to communicate, process and/or manage user registration and/or authentication requests and/or device registration and/or authentication requests. In this regard, the user registration subsystem 304 may be operable to manage user accounts (e.g., create and/or store new user accounts, access, store, update, modify and/or mange existing user accounts), mange user devices (e.g., add, delete, modify, authorize, de-authorize and/or manage devices associated with a particular user account). The user registration subsystem 304 may access, manage and/or process data in the user registration database, such as, for example, the user registration database 302(a). For example, upon receiving a request to create a new user account, the user registration subsystem 304 may create a data entity in the user registration database 302(a).

The recommendation subsystem 305 may comprise suitable logic, circuitry, interfaces, and/or code that may be operable to provide reliable content recommendations (e.g., reliable application recommendations) to users of electronic devices. The recommendation subsystem 305 may be operable to present and/or cause to be presented reliable content recommendations (e.g., reliable application recommendations) to a user of an electronic device. The recommendation subsystem 305 may comprise, for example an entity matching module 315 and/or a recommendation generation module (RGM) 325.

The entity matching module 315 may comprise suitable logic, circuitry, code, and/or interfaces that may be operable to provide entity matching services. In this regard, the entity matching module 315 may analyze user interaction data, such as, for example, user interaction data in the user registration database 302 (a). In this regard, the entity matching module 315 may determine whether the user interaction data may be matched and/or associated with one or more particular entities from the entity database 302(b).

In an example embodiment of the disclosure, the entity matching module 315 may determine whether the user interaction data may be matched and/or associated with one or more particular entities, based on, for example, entity root certificates. For example, the user interaction data may be analyzed for entity root certificates. The entity root certificates may be matched to entity root certificates associated with one or more particular entities in the entity database 302(b).

In an example embodiment of the disclosure, the entity matching module 315 may analyze and/or process the user interaction data that may be associated only with the entities from the entity database 302(b) (matched entities). The entity matching module 315 may determine, for example, the type of user interactions (e.g., e-mail composition, web browsing, etc.), the frequency (e.g., once a day, twice a week, etc.) for each matched entity.

The RGM 325 may comprise suitable logic, circuitry, code, and/or interfaces that may be operable to provide reliable content recommendation services (e.g., reliable application recommendation services) that may be based on entity matching services, such as, for example, the entity matching services provided by the entity matching module 315. In this regard, the RGM 325 may determine one or more applications that may correspond to the matched entities as determined by the entity matching module 315. For example, the RGM 325 may initiate a search on an application database, such as, for example the application database 302(c) to determine one or more applications associated with the matched entities.

In an example embodiment of the disclosure, the RGM 325 may determine one or more recommended applications from the one or more applications. For example, if the RGM 325 determines five (5) applications corresponding to five (5) entities based on, for example, seven (7) matched entities, the RGM 325 may further analyze the user interaction data that may be associated with the five (5) entities (and not all seven (7) matched entities) to which the five (5) applications correspond. The RGM 325 may process and/or analyze the user interaction data to determine one or more recommended applications based on, for example, type and/or frequency of user interactions with a particular entity. The number of recommended applications may be based on, for example, a maximum number of application recommendations and/or may be based on other criteria, such as for example, only recommending applications that are associated with a particular type and/or frequency of user interactions with a particular entity with which the application is associated.

In operation, the recommendation server 300 may be operable to receive, from an electronic device, such as, for example, the electronic device 110, user interaction data. In this regard, the communication subsystem 303 may receive and/or process the user interaction data. The communication subsystem 303 may send the user interaction data (processed or unprocessed) to the recommendation subsystem 305.

The recommendation subsystem 305 may analyze the user interaction data. The recommendation subsystem 305 may determine a particular user with which some or all of the user interaction data is associated. In this regard, the recommendation subsystem 305 may determine a particular user associated with the electronic device from which the user interaction data was received by, for example, initiating a search on the user registration database 302(a).

The recommendation subsystem 305 may determine whether some or all of the user interaction data is associated with a particular entity. In this regard, the recommendation subsystem 305 may request, from the entity matching module 315, for the entity matching module 315 to determine a particular entity (e.g., an entity from the entity database 302(b)) for some or all of the user interaction data. The entity matching module 315 may process (e.g., divide, organize, etc.) the some or all of the user interaction data by a particular entity (e.g., an entity from the entity database 302(b)). The determination may, for example, be based on an entity root certificate associated with some or all of the user interaction data that may be matched to an entity root certificate of an entity in the entity database 302(b).

In an example embodiment of the disclosure, the entity matching module 315 may create an entry in the entity database 302(b) if, for example some or all of the issuer interaction data may not be matched to any exiting entity in the entity database 302(b). For example, if an entity root certificate associated with some or all of the user interaction data cannot be matched with any entity root certificate in the en entity database 302(b), the entity matching module 315 may determine that the some or all of the user interaction data may be associated with a new entity and may create an entry in the entity database 302(b) for the new entity.

The entity matching module 315 may communicate to the recommendation subsystem 305 data and/or information related to one or more entities associated with the user interaction data as determined by the entity matching module 315. For example, the entity matching module may communicate to the recommendation subsystem 305 which parts of the user interaction data correspond to which entity in the entity database 302(b).

In an example embodiment of the disclosure, the recommendation subsystem 305 may store some or all of the user interaction data for a particular user in the user registration database 302(a). For example, the recommendation subsystem 305 may store some or all of the user interaction data for a particular user in the user registration database 302(a) designating specific parts of the user interaction data as associated with a particular entity as determined by the entity matching module 315.

The recommendation server 300 may be operable to receive, from an electronic device, such as, for example, the electronic device 110, a request for reliable content recommendations (e.g., reliable application recommendations). In this regard, the communication subsystem 303 may receive and/or process the request and may send the request (processed or unprocessed) to the recommendation subsystem 305.

The recommendation subsystem 305, in response to the request, may determine a particular user associated with the electronic device 110. In an example embodiment of the disclosure, the recommendation subsystem 305 may initiate a search on a user registration database, such as, for example, the user registration database 302(a), to determine a particular user associated with the electronic device 110.

The recommendation subsystem 305 may request, from the entity matching module 315, for the entity matching module 315, to determine one or more matched entities. In this regard, the entity matching module 315 may initiate a search on a user registration database 302(a) to determine user interaction data associated with the particular user. The user interaction data may comprise entity root certificates. The entity matching module 315 may determine based on, for example, the user interaction data, one or more matched entities. In this regard, the entity matching module 315 may initiate a search on the entity database 302(b) to determine one or more matched entities that may be associated with, for example, the entity root certificates retrieved from the user interaction data. The entity matching module 315 may communicate with the recommendation subsystem 305 and may send to the recommendation subsystem 305 data and/or information relating to the one or more matched entities.

The recommendation subsystem 305 may receive the data and/or information relating to the one or more matched entities. The recommendation subsystem 305 may request, from the RGM 325, for the RGM 325, to determine one or more recommended applications based on, for example, the data and/or information relating to the one or more matched entities. In this regard, the RGM 325 may initiate a search on an application database 302(c) to determine one or more applications associated with the one or more matched entities. For example, the search may be based on a comparison of application-entity root certificates and/or the entity root certificates of the application in the application database 302(c) and of the one or more matched entities. The RGM 325 may also process and/or analyze the data and/or information relating to the one or more matched entities. For example, the RGM 325 may determine the type and/or frequency of user interactions associated with a particular matched entity. The RGM 325 may determine recommended applications form the one or more application, based on, for example, the analysis. The RGM 325 may communicate with the recommendation subsystem 305 and may send to the recommendation subsystem 305 data and/or information relating to the one or more recommended applications.

The recommendation subsystem 305 may determine, based on, for example, the data and/or information received from the RGM 325, reliable content recommendations (e.g., reliable application recommendations). In this regard, the recommendation subsystem 305 may, for example, determine how many of the one or more recommended applications may be recommend to the user of the electronic device 110. The determination may be based on, for example, the type of an electronic device (e.g., the electronic device 110) from which the request for reliable content recommendations (e.g., reliable application recommendations) may have been received and/or the type of an application and/or program (e.g., application store application, web-browser application, etc.) through which the request for reliable content recommendations (e.g., reliable application recommendations) was generated on an electronic device (e.g., the electronic device 110).

In an example embodiment of the disclosure, the ARMS 305 may also analyze data and/or information relating to, for example, which application may have been already purchased, rejected as recommendations and/or marked up or down by the user. In this regard the recommendation subsystem 305 may initiate a search on the user registration database 302(a) to determine which of the one or more recommended applications may be best suitable as reliable content recommendations (e.g., reliable application recommendations) for the user associated with the electronic device (e.g., electronic device 110) from which the request for reliable content recommendations (e.g., reliable application recommendations) was received.

The recommendation subsystem 305 may request, from the communication subsystem 303, for the communication subsystem 303 to send, to the electronic device 110, application recommendation data. The application recommendation data may comprise data and/or information related to the reliable recommend applications (e.g., instructions on how to present the reliable recommend applications to a user of the electronic device 110, etc.) and/or the reliable recommend applications themselves.

In an example embodiment of the disclosure, the application recommendation data may comprise, for example, an indication of a reason for recommending a particular reliable application to the user. The indication may be based on, for example, the user interaction data based on which a particular reliable application recommendation was generated. For example, the indication may be “We thought you might be interested in this Banking Application by Bank A, since you visited Bank's A website 5 this week.”

In another example embodiment of the disclosure, the application recommendation data may comprise, for example, an indication that a particular application is reliable (e.g., is guaranteed to be a first-party application, etc.). For example, the indication may inform the user that the reliable application recommendation is guaranteed to be published (e.g., release to the application store, etc.) by the same entity that the user frequently interacts with. For example, the indication may be: “We have noticed you frequently bank with Bank A. Why don't you try this Bank A Application—it's guaranteed to be reliable, authentic and issued by Bank A!”

The components of the recommendation server 300, such as, for example, the main processor 301, the memory 302, the communication subsystem 303, the user registration subsystem 304, and/or the recommendation subsystem 305 may be implemented in an integrated or a distributed system. An integrated system may be implemented, for example, on one computer, server, machine or device, where the integrated system may be configured to perform some or all of the functions, features and/or operations of the main processor 301, the memory 302, the communication subsystem 303, the user registration subsystem 304, and/or the recommendation subsystem 305 as described herein. A distributed system may be implemented with multiple components (e.g., computers, servers, machines and/or devices), where each of the multiple components may be configured to perform some or all of the functions, features and/or operations of the main processor 301, the memory 302, the communication subsystem 303, the user registration subsystem 304, and/or the recommendation subsystem 305 as described herein. Each function, feature and/or operation may be implemented on one or more of the components of the distributed system. For example, a specific feature, function and/or operation may be implemented on one component of the distributed system or it may be implemented across multiple components of the distributed system.

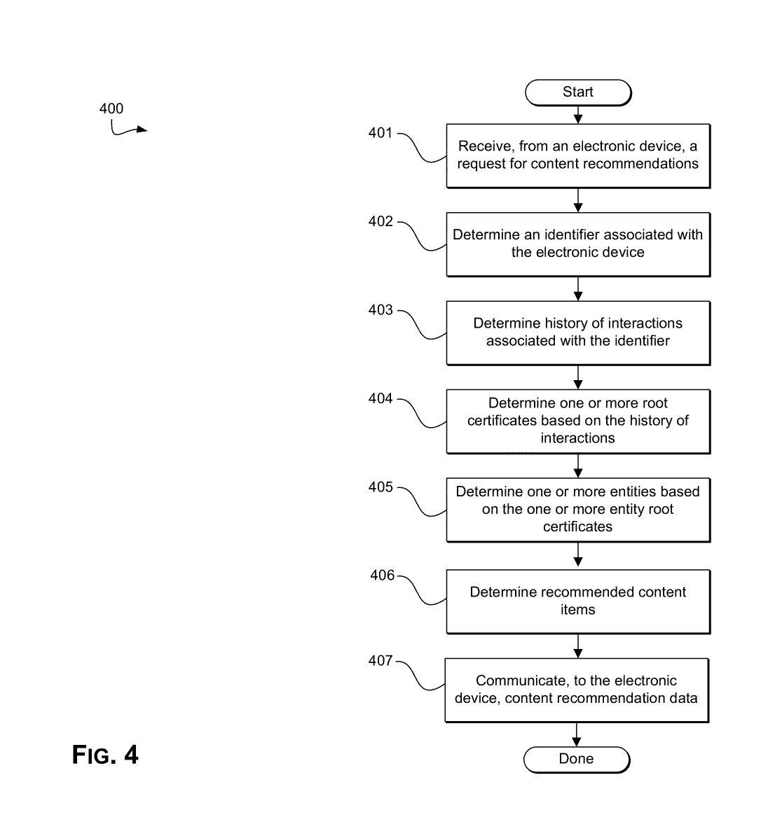

FIG. 4 is a flow diagram of example steps of a method for reliable content recommendations on, in accordance with an example embodiment of the disclosure. Referring to FIG. 4, an example method 400 is shown comprising a plurality of example steps for reliable content recommendations (e.g., reliable application recommendations).

In an example step 401, a request for content recommendations (e.g., application recommendations) may be received from an electronic device, such as, for example, the electronic device 200. In this regard, a recommendation server, such as, for example, the recommendation server 300 may receive and/or process the request. The request may comprise user data (e.g., data and/or information related to a user associated with the electronic device 200, etc.), user interaction data (e.g., user browsing, e-mail and other interactions history, etc.), location data (e.g., date, time, location of the user and/or the electronic device 200, etc.) and/or device related data (e.g. data and/or information associated with the electronic device 200, such as, for example, type, model, etc.) and/or any other data that may be relevant to determining application recommendations by the recommendation server 300.

The request for application recommendations may, for example, be generated by an application running on an electronic device (e.g., application store application, web-browser application, etc.) in response to, for example, a pre-defined criterion, such as for example, a direct user action (e.g., user input indicative of a request for application recommendations, etc.), an indirect user action (e.g., accessing an application store application or a web browser application, etc.), and/or any other pre-defined criterion (e.g., laps of a pre-determined amount of time, detection of a request by an electronic device to access one or more services provided by the recommendation server 300).

In an example step 402, an identifier associated with the electronic device, from which the request in the example step 401 was received, may be determined. The identifier may, for example, correspond to a particular user associated with the electronic device 200. In this regard, the recommendation server 300 may, for example, initiate a search on a user registration database to determine a particular user associated with the electronic device 200.

In an example step 403, a history of interactions (e.g., interaction data, user interaction data, etc.) associated with the identifier (e.g., an identifier corresponding to a particular user) may be determined. The history of interactions may include data and/or information associated with interactions with programs and/or applications (e.g., e-mail, web-browsing, on-line shopping, etc.) on an electronic device (e.g., the electronic device 200) and/or interactions with products and/or services provided by the recommendation server 300, such as, for example, responses to application recommendations from the recommendation server 300 (e.g., whether the recommended content items wert purchased and/or interacted with, whether the recommended content items were marked up or down, etc.). In an example embodiment of the disclosure, the history of interactions may be received, for example, as part of the request for content recommendations.

In another example embodiment of the disclosure, the history of interactions (e.g., history of user interactions) may be determined by the recommendation server 300. For example, the application server 300 may initiate a search on a user registration database to determine history of interactions (e.g., history of user interactions, user interaction data, etc.) associated with the identifier (e.g., an identifier corresponding to a particular user)

In an example step 404, one or more root certificates (e.g., entity root certificates application-entity root certificates, etc.) based on the history of interactions. In this regard, the recommendation server 300 may analyze the history of interactions to determine one or more root certificates.

In an example step 405, one or more entities may be determined based on the one or more root certificates. In this regard, the recommendation server 300 may initiate a search on an entity database to determine one or more entities associated with the one or more root certificates.

In an example step 406, recommended content items may be determined. For example, the recommendation server 300 may initiate a search on an application database based to determine one or more content items (e.g., applications) corresponding to the one or more entities.

In an example embodiment of the disclosure, the recommendation server 300 may analyze a history of interactions with the products and/or services offered by the application recommendations server 300. For example, the recommendation server 300 may initiate a search on a user registration database to determine whether the particular user interacted (e.g. purchased, rejected as recommendations, marked up or down, etc.) with the one or more applications.

In an example embodiment of the disclosure, the recommendation server 300 may further determine, for example, which of the one or more applications to recommend to the particular user. In this regard, the recommendation server 300 may analyze the history of interactions (e.g., history of user interactions, user interaction data, etc.) that may correspond to one or more entities with which the one or more content items (e.g., applications) are associated. For example, the recommendation server 300 may determine the type and/or the frequency of user interactions. The recommendation server 300 may, based on, for example, the type and/or the frequency of user interactions and/or the history of user interactions with the products and/or services provided by the recommendation server 300 determine reliable recommended content items (e.g., applications) for the particular user.

In an example step 407, content recommendation data may be sent to the electronic device 200. The content recommendation data may, for example, instructions for presenting one or more reliable recommended content items (e.g., applications), such as, for example, the content items determined in the example step 406, on the electronic device 200 and/or the reliable recommended content items (e.g., applications) themselves. In an example embodiment of the disclosure, the content recommendation data may comprise, for example, an indication of a reason for recommending a particular reliable content item (e.g., application) to a particular user and/or an indication that a particular content item (e.g., application) is reliable (e.g., is guaranteed to be a first-party content item, etc.).

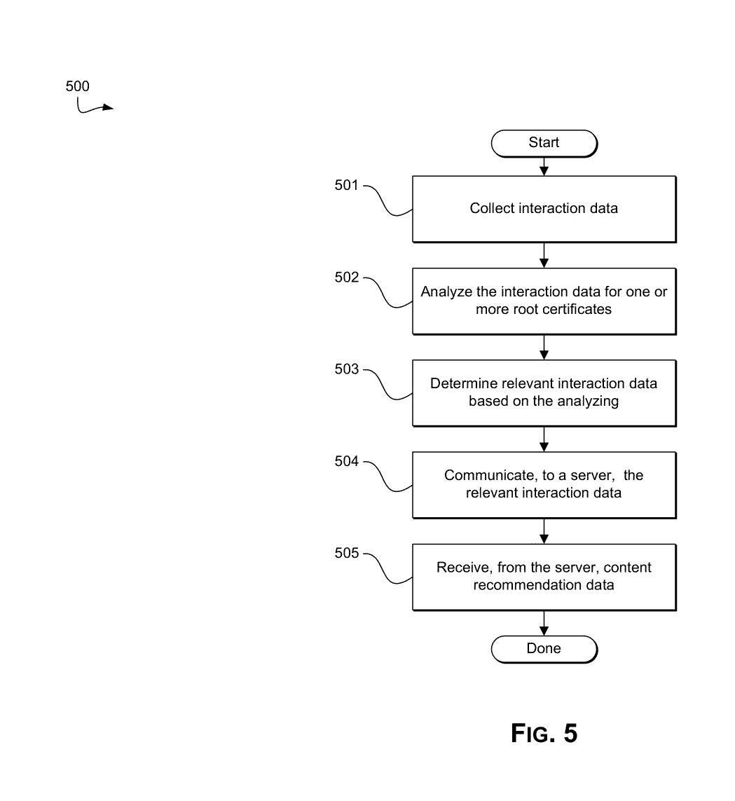

FIG. 5 is a flow diagram of example steps of another method for reliable content recommendations, in accordance with an example embodiment of the disclosure. Referring to FIG. 5, an example method 500 is shown comprising a plurality of example steps for reliable content recommendations (e.g., reliable application recommendations).

In an example step 501, interaction data may be collected. In this regard, an electronic device may analyze data related to, for example, application access, web-browsing, and/or e-mail massage composition. The interaction data may be treated so that so that no personally identifiable information can be determined.

In an example step 502, the interaction data may be analyzed for one or more root certificates. In this regard, the interaction data may be grouped by, for example, a particular entity that may be associated with an entity root certificate. For example, interaction data associated with a particular entity root certificate may be grouped and/or processed together.

In an example step 503, relevant interaction data may be determined. In this regard, the relevant interaction data may be determined based on, for example, the analysis performed in the example step 502. For example, the relevant interaction data may be determined to comprise data that may be related to entity root certificates (e.g., data that may not be associated with any entity root certificates may be considered irrelevant).

In an example step 504, the relevant interaction data may be communicated to a server, such as, for example, the recommendation server 300. In this regard the relevant interaction data may be sent to the recommendation server 300.

In an example step 505, content recommendation data may be received from the server. The content recommendation data may be based on, for example, the relevant interaction data and/or may include data and/or information related to reliable content recommendations (e.g., reliable application recommendations). For example, the content recommendation data may comprise, for example, instructions on how to present reliable recommended content items (e.g., applications) on an electronic device, from which the relevant interaction data was sent, and/or the reliable recommended content items (e.g., applications) themselves. The content recommendation data may comprise, for example, an indication that a particular content item (e.g., application) is reliable (e.g., is guaranteed to be a first-party content item, etc.).

Other implementations may provide a computer readable medium and/or storage medium, and/or a machine readable medium and/or storage medium, having stored thereon, a machine code and/or a computer program having at least one code section executable by a machine and/or a computer, thereby causing the machine and/or computer to perform the steps as described herein for reliable content recommendations (e.g., reliable application recommendations).

Accordingly, the present method and/or system may be realized in hardware, software, or a combination of hardware and software. The present method and/or system may be realized in a centralized fashion in at least one computing system, or in a distributed fashion where different elements are spread across several interconnected computing systems. Any kind of computing system or other system adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A method, comprising:
in a computing device:
receiving, from an electronic device, a request for one or more content recommendations;
determining an identifier associated with the electronic device;
determining a history of interactions, wherein the interactions are associated with the identifier;
determining one or more entity root certificates based on the history of interactions;
determining one or more entities based on the one or more entity root certificates;
determining one or more recommended content items, wherein the one or more recommended content items are associated with one or more of the one or more entities;
communicating, to the electronic device, content recommendation data, wherein the content recommendation data comprises data related to the one or more recommended content items.

2. The method of claim 1, wherein the identifier corresponds to a particular user and wherein the history of interactions comprises the particular user's interactions with web, e-mail or applications.

3. The method of claim 1, wherein the one or more entities are related to the history of interactions.

4. The method of claim 3, wherein the one or more entity root certificates comprises security data.

5. The method of claim 4, wherein the security data may indicate that the one or more entities are related to the history of interactions.

6. The method of claim 2, wherein the content recommendation data comprises one or more indicators, each associated with one of the one or more recommended content items.

7. The method of claim 6, wherein one or more of the one or more indicators may be related to a reason for recommending one or more of the one or more recommended content items.

8. The method of claim 6, wherein one or more of the one or more indicators comprises data related to informing the particular user that one or more of the one or more recommended content items is reliable.

9. A method comprising:
in an electronic device:
collecting interaction data;
analyzing interaction data for one or more root certificates;
determining relevant interaction data based on the analyzing;
communicating, to a server, the relevant interaction data, and
receiving, from the server, content recommendation data, wherein the content recommendation data is based on the relevant interaction data.

10. The method of claim 9, wherein the content recommendation data comprises one or more recommended content items and one or more indicators, each associated with one or more of the one or more recommended content items.

11. A system comprising:
one or more processors, the one or more processors being operable to:
receive, from an electronic device, a request for one or more content recommendations;
determine an identifier associated with the electronic device;
determine a history of interactions, wherein the interactions are associated with the identifier;
determine one or more entity root certificates based on the history of interactions;
determine one or more entities based on the one or more entity root certificates;
determine one or more recommended content items, wherein the one or more recommended content items are associated with one or more of the one or more entities;
communicate, to the electronic device, content recommendation data, wherein the content recommendation data comprises data related to the one or more recommended content items.

12. The system of claim 11, wherein the identifier corresponds to a particular user and wherein the history of interactions comprises the particular user's interactions with web, e-mail or applications.

13. The system of claim 1, wherein the one or more entities are related to the history of interactions.

14. The system of claim 13, wherein the one or more entity root certificates comprises security data.

15. The system of claim 14, wherein the security data may indicate that the one or more entities are related to the history of interactions.

16. The system of claim 12, wherein the content recommendation data comprises one or more indicators, each associated with one of the one or more recommended content items.

17. The system of claim 16, wherein one or more of the one or more indicators may be related to a reason for recommending one or more of the one or more recommended content items.

18. The system of claim 16, wherein one or more of the one or more indicators comprises data related to informing the particular user that one or more of the one or more recommend content items is reliable.

19. A system comprising:
one or more processors, the one or more processors being operable to:
collect interaction data;
analyze interaction data for one or more root certificates;
determine relevant interaction data based on the analyzing;
communicate, to a server, the relevant interaction data, and
receive, from the server, content recommendation data, wherein the content recommendation data is based on the relevant interaction data.

20. The system of claim 19, wherein the content recommendation data comprises one or more recommended content items and one or more indicators, each associated with one or more of the one or more recommended content items.
